(19) United States
(12) Patent Application Publication
(10) Pub. No.: US 2013/0038172 A1
(43) Pub. Date: Feb. 14, 2013

(54) MOTOR APPARATUS, METHOD OF DRIVING ROTOR, AND ROBOT APPARATUS

(71) Applicant: NIKON CORPORATION, Tokyo (JP)

(72) Inventors: Takashi Nagase, Tokyo (JP); Tohru Kiuchi, Tokyo (JP)

(73) Assignee: NIKON CORPORATION, Tokyo (JP)

(21) Appl. No.: 13/630,859

(22) Filed: Sep. 28, 2012

Related U.S. Application Data
(63) Continuation of application No. PCT/JP2011/057983, filed on Mar. 30, 2011.

(30) Foreign Application Priority Data
Mar. 31, 2010 (JP) 2010-080347

(51) Int. Cl. H02N 2/12

(52) U.S. Cl. 310/323.02

(57) ABSTRACT

A motor apparatus includes a rotor, a contact member wound around at least a part of a circumference of the rotor, a driving unit connected to the contact member and moves the contact member, a magnifying mechanism magnifying a degree of movement of the contact member based on a degree of drive of the driving unit and transmitting the magnified degree of movement to the contact member, and a control unit controlling the driving unit to perform a driving action of moving the contact member in a predetermined distance while setting up a torque transmission state between the rotor and the contact member, and a returning action of returning the contact member to a predetermined position while having the torque transmission state released.

### CROSS-REFERENCE TO RELATED APPLICATIONS

This is a Continuation Application of International Application No. PCT/JP2011/057983, filed Mar. 30, 2011, which claims priority to Japanese Patent Application No. 2010-080347 filed on Mar. 31, 2010, the contents of which are hereby incorporated by reference in their entirety.

### BACKGROUND

### Field of the Invention

The present invention relates to a motor apparatus, a method of driving a rotor, and a robot apparatus.

For example, a motor apparatus is used as an actuator driving a revolving type machine.

Motor apparatuses of this type capable of generating a relatively high torque, such as an electric motor or an ultrasonic motor, are widely known (For example, see Japanese Unexamined Patent Application, First Publication No. H2-311237). In recent years, there has been a need for a motor apparatus driving more precise parts such as a joint of a humanoid robot. In existing motors such as an electric motor or an ultrasonic motor, there is also a need for a configuration enabling a minute and high-precision driving operation with a decrease in size, a high controllability of torque, and the like.

### SUMMARY

However, for example, in an electric motor or an ultrasonic motor, it is necessary to mount a reduction gear thereon so as to generate a high torque and thus the decrease in size thereof is limited.

An object of an aspect of the invention is to provide a motor apparatus, a method of driving a rotor, and a robot apparatus, which can generate a high torque.

According to a first aspect of the invention, there is provided a motor apparatus including: a rotor; a contact member wound around at least a part of a circumference of the rotor; a driving unit that is connected to the contact member and that moves the contact member; a magnifying mechanism that magnifies a degree of movement of the contact member based on a degree of drive of the driving unit and that transmits the magnified degree of movement to the contact member; and a control unit that controls the driving unit to perform a driving action of moving the contact member in a predetermined distance while setting up a torque transmission state between the rotor and the contact member, and a returning action of returning the contact member to a predetermined position while having the torque transmission state released.

According to a second aspect of the invention, there is provided a method of driving a rotor, including: a driving step that moves a contact member wound around a rotor in a predetermined distance while setting up a torque transmission state between the rotor and the contact member by the driving of a driving unit; and a returning step of returning the contact member to a predetermined position while having the torque transmission state released by the driving of the driving unit, wherein at least one of the driving step and the returning step includes a magnification step of magnifying a degree of movement of the contact member based on a degree of drive of the driving unit and transmitting the magnified degree of movement to the contact member.

According to a third aspect of the invention, there is provided a robot apparatus including: a rotating shaft member; and a motor apparatus that causes the rotating shaft member to rotate, wherein the above-mentioned motor apparatus is used as the motor apparatus.

According to the aspect of the invention, it is possible to provide a motor apparatus which can generate a high torque.

### BRIEF DESCRIPTION OF THE DRAWINGS

FIG. 1 is a diagram schematically illustrating the configuration of an example of a motor apparatus according to a first embodiment.

FIG. 2 is a diagram illustrating a rotor according to the first embodiment, where the rotor is developed around an axis of rotation.

FIG. 3 is a plan view illustrating a driving unit according to the first embodiment.

FIG. 4 is a diagram illustrating a set of a driving unit and a contact member in the first embodiment.

FIG. 5 is a diagram illustrating a relationship between a degree of displacement magnification and a Moonie angle in the first embodiment.

FIG. 6A is a timing diagram of a laminated piezoelectric element in the first embodiment.

FIG. 6B is a timing diagram of a laminated piezoelectric element in the first embodiment.

FIG. 6C is a timing diagram of a laminated piezoelectric element in the first embodiment.

FIG. 7 is a diagram schematically illustrating the configuration of an example of a motor apparatus according to a second embodiment.

FIG. 8 is a diagram schematically illustrating the configuration of an example of a motor apparatus according to a third embodiment.

FIG. 9 is a plan view illustrating the configuration of a driving unit according to the third embodiment.

FIG. 10 is a front view illustrating the configuration of a driving unit according to the third embodiment.

FIG. 11A is a front view of a rotor according to a fourth embodiment.

FIG. 11B is a front view of a rotor according to the fourth embodiment.

FIG. 11C is a front view of a rotor according to the fourth embodiment.

FIG. 12 is a schematic diagram illustrating an application example of a motor apparatus according to a fifth embodiment.

FIG. 13A is a diagram illustrating another configuration of the motor apparatus according to the present embodiment.

FIG. 13B is a diagram illustrating still another configuration of the motor apparatus according to the present embodiment.

FIG. 14 is a diagram illustrating still another configuration of the motor apparatus according to the present embodiment.

FIG. 15A is a diagram illustrating other configurations of the motor apparatus according to the present embodiment.

FIG. 15B is a diagram illustrating other configurations of the motor apparatus according to the present embodiment.

FIG. 15C is a diagram illustrating other configurations of the motor apparatus according to the present embodiment.

FIG. 16 is a graph illustrating characteristics of the motor apparatus according to the present embodiment.

### DESCRIPTION OF EMBODIMENTS

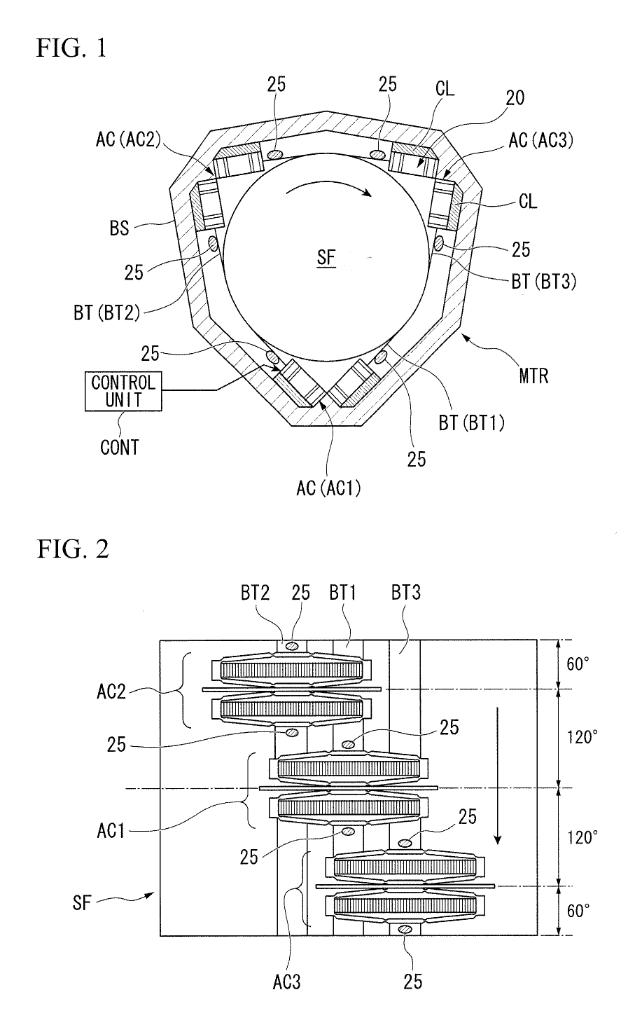

Hereinafter, a motor apparatus, a method of driving a rotor, and a robot apparatus according to embodiments of the invention will be described with reference to FIGS. 1 to 16.

### First Embodiment

A first embodiment of the invention will be described below. FIG. 1 is a diagram schematically illustrating the configuration of an example of a motor apparatus MTR according to the embodiment.

As shown in FIG. 1, the motor apparatus MTR includes a rotor SF, a contact member (belt) BT, a driving unit AC, a fixed member BS, and a control unit CONT. Plural bearings holding the rotor SF and the like are not shown in the drawing.

The motor apparatus MTR has a configuration in which the contact member BT connected to the driving unit AC wound around at least a part of a circumference (e.g., an inner circumference, an outer circumference) of the rotor SF in a state where the driving unit AC is supported by the fixed member BS. The control unit CONT is connected to the driving unit AC and can supply a control signal to the driving unit AC.

The driving unit AC is connected to both ends of the contact member BT and is fixed to the fixed member BS with a gel-like coolant CL interposed therebetween. Three sets of the driving units AC and the contact members BT are arranged with a gap of 120° in a circumferential direction of the rotor SF, as shown in FIG. 1. These three sets of the driving units AC and the contact members BT are arranged with a gap in the axis direction in which the rotor SF is developed around the axis of rotation, as shown in FIG. 2, such that the contact members BT do not overlap with each other. The three sets of the driving units AC and the contact members BT are appropriately referred to as the driving units AC1 to AC3 and the contact members (belts) BT1 to BT3.

The contact member BT is formed in a belt shape out of an elastically-deformable material and is wound around the rotor SF, for example, with a length of 240° (⅔ circumference). Each of the three contact members BT has a same width. The frictional coefficient between the three contact members BT and the rotor SF is set to, for example, 0.3. A detector 25 detecting the tension of the corresponding contact member BT is disposed in a vicinity of the ends of each contact member BT (in the vicinity of connecting portions to each driving unit AC).

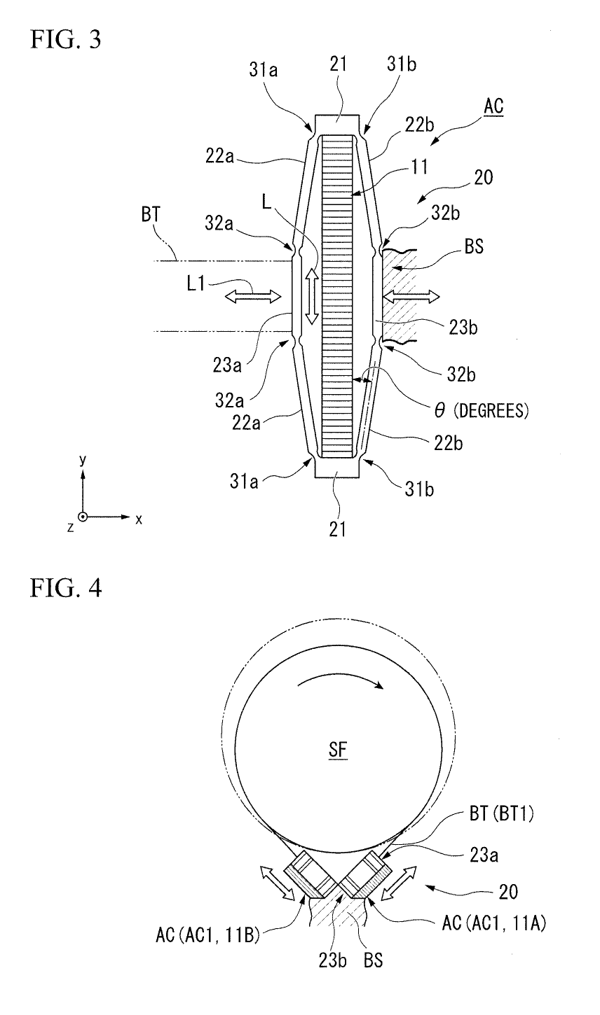

FIG. 3 is a plan view of driving unit AC.

The driving unit AC shown in FIG. 3 includes a laminated piezoelectric element (electrostrictive element) 11 expanding and contracting (being driven) in the length direction (the vertical direction in FIG. 3) according to the electrification from the control unit CONT and a magnifying mechanism 20 magnifying the degree of drive of the laminated piezoelectric element 11. For example, a piezoelectric element is used as the laminated piezoelectric element 11. In FIG. 3, the length direction (the laminated direction or the expansion and contraction direction) of the laminated piezoelectric element 11 is defined as a y direction, the width direction (the horizontal direction in FIG. 3) perpendicular to (crossing) the y direction is defined as an x direction, and the thickness direction perpendicular to the x direction and the y direction is defined as a z direction.

The magnifying mechanism 20 includes a Moonie converter that converts the movement direction of the corresponding contact member BT into the x direction which is substantially perpendicular to the expansion and contraction direction of the laminated piezoelectric element 11 by the use of the driving force of the laminated piezoelectric element 11, and that magnifies the degree of movement of the contact member BT based on the degree of drive (the degree of expansion and contraction) of the laminated piezoelectric element 11 and transmits the magnified degree of movement to the contact member BT. The Moonie converter includes a fixed portion 21 disposed at both ends in the length direction of the laminated piezoelectric element 11, pairs of rod portions 22a and 22a, and 22b and 22b that are disposed at both ends in the x direction of the laminated piezoelectric element 11 and of which one end of each is connected to the fixed portion 21 via hinge portions 31a and 31b, which have a swing support point around an axis line extending in the z axis direction (the first direction), and rod portions 23a and 23b that are connected to the other end of each of the pair of rod portions 22a and 22a via hinge portions 32a and 32b allowing a swing around an axis line extending in the z axis direction (the second direction). The total length of the rod portions 22a, 22a, and 23a (the rod portions 22b, 22b, and 23b) is set to be substantially the same as the length (natural length) of the laminated piezoelectric element 11 in a non-electrified state.

FIG. 4 is a diagram illustrating a set of the driving unit AC and the contact member BT (the detector 25 is not shown in FIG. 4).

As shown in FIGS. 3 and 4, the driving unit AC is connected to the contact member BT set on the rotor SF via the rod portion 23a at one end in the width direction, and is connected to the fixed member BS at the other end in the width direction. The driving AC is connected to the fixed member BS in a state where the width direction (the x direction) of the driving AC is matched with the tangential direction between the contact member BT and the rotor SF.

Among the movements of the motor apparatus MTR which has the above-mentioned configuration, the movement of the magnifying mechanism 20 will be described below. In the magnifying mechanism 20 shown in FIG. 3, since the movements of the rod portions 22a, 22a, and 23a and the actions of the rod portions 22b, 22b, and 23b are the same, the movements of the rod portions 22a, 22a, and 23a will be described herein.

When the laminated piezoelectric element 11 contracts, for example, in the length direction (the y direction) through the electrification, since the fixed portions 21 and 21 fixed to both ends of the laminated piezoelectric element 11 move in a direction in which both approaches each other and the distance between the fixed portions 21 and 21 becomes shorter, the other end of each of the rod portions 22a and 22a swings around the z axis in a direction in which it gets apart from the laminated piezoelectric element 11 as having one end of the hinge portion 31 as a swing center. At this time, since the swing tips (the other end tips) of the rod portions 22a and 22a are separated from the laminated piezoelectric element 11 by substantially the same distance from the laminated piezoelectric element 11, the rod portion 23a connected between the other ends of the rod portions 22a and 22a moves in the −x direction in which it is separated from the laminated piezoelectric element 11.

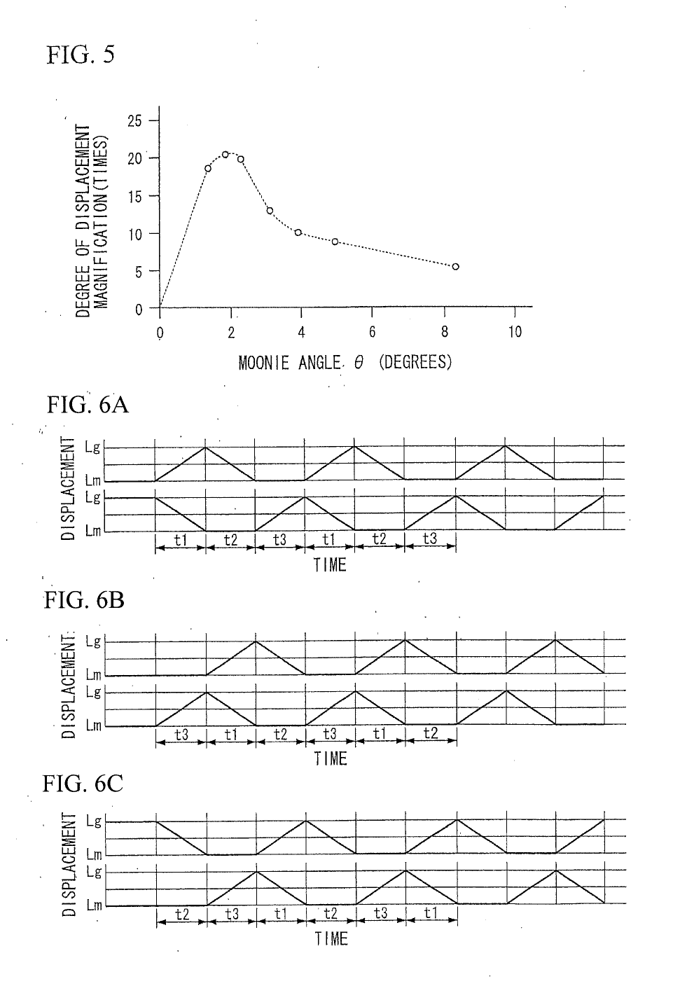

Here, the correlation between the degree of drive (herein, the degree of contraction) L of the laminated piezoelectric element 11 and the degree of movement L1 in the x direction of the rod portion 23a varies depending on the angle (the angle about the y axis, which is a so-called Moonie angle) 8 at which the rod portion 22a is inclined by the driving of the laminated piezoelectric element 11. FIG. 5 shows the relationship between the degree of displacement magnification, which is expressed by the ratio (L1/L) of the degree of movement L1 in the x direction of the rod portion 23a to the degree of drive L of the laminated piezoelectric element 11, and the Moonie angle θ (see “Next-Generation Actuators Leading Breakthroughs”, Specific Category Research, Grant-in-Aid for Scientific Research of the Ministry of Education, Culture, Sports, Science, and Technology, the 5^{th} Public Symposium, P38). As shown in FIG. 5, the degree of displacement magnification is the largest (about twenty times) when the Moonie angle θ is about 2 degrees.

Accordingly, by driving the laminated piezoelectric element 11 by the degree of drive at which the Moonie angle θ is about two degrees, the magnifying mechanism 20 forms a degree of movement L1, which is obtained by magnifying the degree of drive L of the laminated piezoelectric element 11 to about twenty times, to move the rod portion 23a. For the rod portions 22b, 22b, and 23b, similarly to the rod portions 22a, 22a, and 23a, the magnifying mechanism 20 forms a degree of movement L1, which is obtained by magnifying the degree of drive L of the laminated piezoelectric element 11 to about twenty times, to move the rod portion 23b. Accordingly, as shown in FIG. 4, in the configuration in which the rod portion 23b is fixed to the fixed member BS and the rod portion 23a is connected to the contact member BT, the contact member BT can move with a degree of movement which is about 40 times of the degree of drive L of the laminated piezoelectric element 11.

When the laminated piezoelectric element 11 expands in the length direction, by a reverse movement than the above-mentioned movement, the rod portions 23a and 23b move in a direction, in which both get closer to the laminated piezoelectric element 11 in a state where both expand in the y direction, with the degree of movement obtained by magnifying the degree of drive L of the laminated piezoelectric element 11.

The method of driving the rotor SF using the above-mentioned motor apparatus MTR will be described below.

When driving the rotor SF, an effective tension is generated in the contact member BT wound around the rotor SF and a torque is transmitted to the rotor SF by the use of the effective tension.

FIG. 6A is a diagram illustrating a relationship between an elapsed time (the horizontal axis) and the degree of displacement (degree of drive: the vertical axis) of the laminated piezoelectric element 11 in the driving unit AC1. The upper part of FIG. 6A shows the relationship between the elapsed time and the degree of displacement of the laminated piezoelectric element 11 (referred to as laminated piezoelectric element 11A for the purpose of convenience of explanation) in the driving unit AC1 located on the front side in the rotation direction (the clockwise direction in FIG. 4) of the rotor SF shown in FIG. 4. The lower part of FIG. 6A shows the relationship between the elapsed time and the degree of displacement of the laminated piezoelectric element 11 (referred to as laminated piezoelectric element 11B for the purpose of convenience of explanation) in the driving unit AC1 located on the rear side in the rotation direction of the rotor SF.

Similarly, FIGS. 6B and 6C are diagrams illustrating the relationship between the elapsed time (the horizontal axis) and the degree of displacement (the degree of drive: the vertical axis) of the laminated piezoelectric element 11 in the driving units AC2 and AC3, respectively. The upper part of FIGS. 6B and 6C show the relationship between the elapsed time and the degree of displacement of the laminated piezoelectric element 11A in each of the driving units AC2 and AC3 located on the front side in the rotation direction of the rotor SF. The lower part of FIGS. 6B and 6C show the relationship between the elapsed time and the degree of displacement of the laminated piezoelectric element 11B in each of the driving units AC2 and AC3 located on the rear side in the rotation direction of the rotor SF.

The degree of displacement Lg in FIGS. 6A, 6B, and 6C represents the degree of displacement when the laminated piezoelectric elements 11A and 11B expand (when the rod portions 23a and 23b (the end portions of the contact members BT) are made to move in a direction in which both get closer to the laminated piezoelectric element 11 by the use of the magnifying mechanism 20). The degree of displacement Lm in FIGS. 6A, 6B, and 6C represent the degree of displacement when the laminated piezoelectric element 11A and 11B contract (when the rod portions 23a and 23b (the end portions of the contact member BT) are made to move in a direction in which both are separated from the laminated piezoelectric element 11 by the use of the magnifying mechanism 20).

In the each of the driving units AC1 to AC3, when the laminated piezoelectric element 11A contracts with the degree of displacement Lm and the laminated piezoelectric element 11B expands with the degree of displacement Lg, the effective tension which can transmit a torque to the rotor SF is given to the contact member BT wound around the rotor SF.

First, the method of driving the rotor SF using the driving unit AC1 will be described with reference to FIG. 6A.

First, from the initial state where the laminated piezoelectric element 11A is driven with the degree of displacement Lm and the laminated piezoelectric element 11B is driven with the degree of displacement Lg to give an effective tension to the contact member BT, during the interval of time t1, the laminated piezoelectric element 11A is driven with the degree of displacement Lg to move an end portion of the contact member BT1 in a predetermined distance in the direction in which it gets closer to the driving unit AC1, and the laminated piezoelectric element 11B is driven with the degree of displacement Lm to move an end portion of the contact member BT1 in a predetermined distance in the direction in which it is separated from the driving unit AC1. Accordingly, a torque transmission state is set up and a torque in the clockwise direction is given to the rotor SF in the state where the above-mentioned effective tension is maintained (driving action).

Then, during the interval of time t2, in the state where the degree of displacement Lm of the laminated piezoelectric element 11B is maintained, the laminated piezoelectric element 11A is driven with the degree of displacement Lm to cause an end portion of the contact member BT1 to move in the direction in which it is separated from the driving unit AC1. Accordingly, as indicated by a two-dot chained line in FIG. 4, the contact member BT1 is loosened and the torque transmission state is released and the rotor SF is released from the tension given from the contact member BT1.

Subsequently, during the interval of time t3, in the state where the degree of displacement Lm of the laminated piezoelectric element 11A is maintained, the laminated piezoelectric element 11B is driven with the degree of displacement Lg to move an end portion of the contact member BT1 in the direction in which it gets closer to the driving unit AC1. Accordingly, the contact member BT1 gives the effective tension to the rotor SF again, and returns to the initial state where a torque is not given thereto (returning action).

Thereafter, by repeating the actions of the intervals of time t1 to t3, the contact member BT1 intermittently gives a torque to the rotor SF to rotate the rotor SF continuously in the clockwise direction.

However, in driving the rotor SF by the above-mentioned driving unit AC1, for example, during the interval of time t2, the contact member BT1 is loosened and the rotor SF may reversely rotate with a disturbance torque. Therefore, in the present embodiment, as shown in FIGS. 6B and 6C, the control unit CONT adjusts the driving of the laminated piezoelectric elements 11A and 11B in the driving units AC2 and AC3 so that the intervals of time t1 to t3 do not overlap with each other. Accordingly, since the interval of time t1 in which a torque is given to the rotor SF by the contact members BT2 and BT3 is continuous, it is possible to cause the rotor SF to stably rotate in the clockwise direction.

When the rotor SF is made to rotate in a counterclockwise direction, according to the relationship between the time and the degree of displacement shown in FIGS. 6A-6C, the voltage applied to the laminated piezoelectric element 11A and the voltage applied to the laminated piezoelectric element 11B have only to be inverted so that the degrees of displacement Lg and Lm are inverse.

When the rotor SF is rotationally driven using the driving units AC1 to AC3 and the contact members BT1 to BT3, the degrees of displacement of the laminated piezoelectric elements 11A and 11B may be adjusted depending on the tension detection result of the detectors 25. That is, by detecting the tensions of the contact members BT1 to BT3 through the use of the detectors 25 and by adjusting the degrees of displacement of the laminated piezoelectric elements 11A and 11B in the driving units AC1 to AC3 connected to the contact members BT1 to BT3 when the detected tensions departs from a predetermined range, the torque given to the rotors SF can be set within the predetermined range and the rotor SF can be stably rotated.

According to the present embodiment, since the driving units AC can be made to perform the driving action and the returning action in the state where the contact members BT are set on at least a part of the rotor SF, it is possible to give a high torque to the rotor SF even without providing a reduction gear and even with a small-sized driving unit AC. As a result, it is possible to obtain a small-sized motor apparatus MTR which can generate a high torque. It is also possible to cause the rotor SF to rotate with a high efficiency even with a small-sized driving unit AC.

For example, when the degree of displacement of the laminated piezoelectric element 11 is set to about 0.1% of the length thereof, it is necessary to set the length of the laminated piezoelectric element 11 to be very large in order to enlarge the degree of drive of the laminated piezoelectric element 11 depending on the degree of movement of the contact member BT, and thus the increase in size of the apparatus cannot be avoided. However, as described above, according to the present embodiment, since the magnifying mechanism 20 magnifies the degree of movement of the contact member BT based on the degree of drive of the laminated piezoelectric element 11 and transits the magnified degree of movement to the contact member BT, it is possible to increase the degree of movement of the contact member BT without increasing the length of the laminated piezoelectric element 11.

In this embodiment, since the Moonie converter is used as the magnifying mechanism 20, the movement direction of the contact member BT can be converted into the direction substantially perpendicular to the driving direction of the laminated piezoelectric element 11 and it is thus possible to suppress an increase in size of the apparatus in the length direction of the laminated piezoelectric element 11. Particularly, in the present embodiment, since the magnifying mechanism 20 magnifies the degree of movement of the contact member BT on the basis of the degree of drive of the laminated piezoelectric element 11 to both ends in the width direction (the x direction) of the laminated piezoelectric element 11, it is possible to further increase the degree of movement of the contact member BT. Therefore, in the present embodiment, it is possible to raise the rotation speed of the rotor SF by the use of the magnifying mechanism 20.

### Second Embodiment

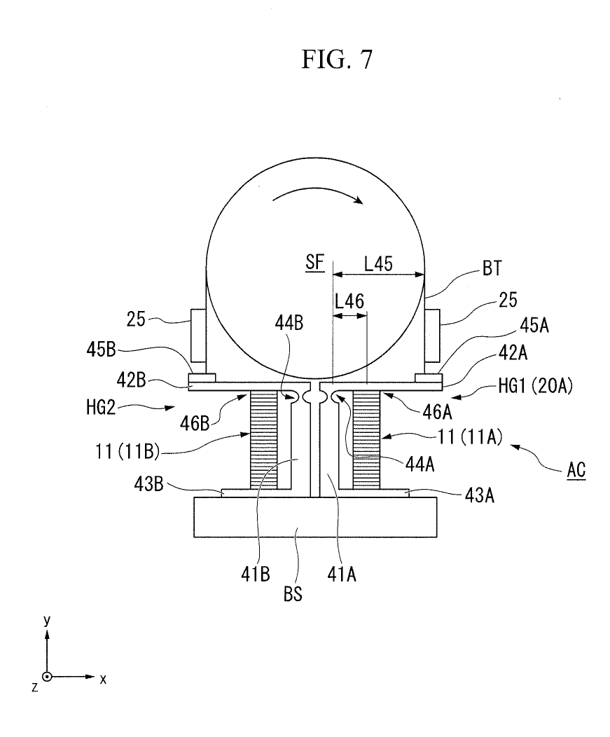

A second embodiment of the invention will be described below with reference to FIG. 7. In FIG. 7, the same elements as described in the first embodiment shown in FIG. 4 are referenced by the same reference numerals and the description thereof will not be repeated.

The above-mentioned first embodiment has the configuration in which the magnifying mechanism 20 setting the movement direction of the contact member BT to the direction substantially perpendicular to the driving direction of the laminated piezoelectric element 11 is employed. However, the driving unit AC according to the present embodiment employs a magnifying mechanism 20A setting the movement direction of the contact member BT to be substantially parallel to the driving direction of the laminated piezoelectric element 11. Also in the present embodiment, the direction of the axis of rotation of the rotor SF is defined as the z direction, the driving direction of the laminated piezoelectric element 11 is defined as the y direction, and the direction perpendicular to the z direction and the y direction is defined as the x direction.

As shown in FIG. 7, the magnifying mechanism 20A includes hinge apparatuses HG1 and HG2 that are disposed at the fixed member BS and that are directed to the directions in which both face each other. The hinge apparatus HG1 includes a rod portion 41A extending in the y direction, a rod portion 42A disposed at an end portion in the +y direction of the rod portion 41A and extending in the x direction, a rod portion 43A disposed at an end portion in the −y direction of the rod portion 41A and extending in the x direction, and a hinge portion 44A.

The hinge portion 44A is disposed at the vicinity of the connecting portion of the rod portion 41A and the rod portion 42A, and has a swing support point of the axis of rotation extending in the z axis direction so as to allow the rod portion 42A to swing about the swing support point relative to the rod portion 41A. The rod portion 43A is fixed to the fixed member BS.

An end of the contact member BT is connected to a connecting portion 45A located at an end portion on the swing tip side (the +x side) of the rod portion 42A. The contact member BT in the present embodiment is wound on the rotor SF, for example, with a length of 180° (½ circumference) with the y axis direction as the tangential direction. The laminated piezoelectric element 11 (11A) is fixed in a state where it is pinched between the rod portion 42A and the rod portion 43A, while having the y axis direction as the driving direction (the length direction) thereof. The connecting portion (the second connecting portion) 46A of the rod portion 42A which connects with the laminated piezoelectric element 11A is disposed between the swing support point of the hinge portion 44A and the connecting portion 45A.

Since the hinge apparatus HG2 is different from the hinge apparatus HG1 in that the hinge apparatus HG2 and the hinge apparatus HG1 are symmetric about a line crossing the axis of rotation of the rotor SF and extending in the y axis direction, the corresponding subscript in the hinge apparatus HG1 is changed from A to B and the description thereof will not be repeated.

In the driving unit AC having the above-mentioned configuration, when the laminated piezoelectric element 11A contracts, for example, in the length direction because of the electrification, the rod portion 42A swings in the clockwise direction around the z axis as having the hinge portion 44A as the swing support point. By the swing of the rod portion 42A using the hinge portion 44A as a swing support point, the connecting portion 45A moves substantially in the −y direction. The degree of movement of the connecting portion 45A is set depending on the position of the connecting portion 46A where the laminated piezoelectric element 11A of the rod portion 42A is connected.

When the distance between the connecting portion 46A and the hinge portion 44A is defined as L46 and the distance between the connecting portion 45A and the hinge portion 44A is defined as L45, the degree of movement of the connecting portion 45A is expressed by the following Expression 1.

(Degree of Displacement of Laminated Piezoelectric Element 11A)×(L45/L46) Expression 1

According to the Expression 1, the degree of movement of the connecting portion 45A is an amount which is obtained by magnifying the degree of displacement (the degree of drive) of the laminated piezoelectric element 11A to (L45/L46) times by the use of the magnifying mechanism 20A.

Therefore, an end of the contact member BT connected to the connecting portion 45A moves in the −y direction substantially parallel to the driving direction of the laminated piezoelectric element 11A by the degree of movement obtained by magnifying the degree of displacement of the laminated piezoelectric element 11A.

Regarding the method of driving the rotor SF, similarly to the first embodiment, it is possible to rotate the rotor SF by driving the laminated piezoelectric elements 11A and 11B with the elapsed time shown in FIGS. 6A-6C.

Accordingly, in the present embodiment, since the magnifying mechanism 20A magnifies the degree of movement of the contact member BT on the basis of the degrees of drive of the laminated piezoelectric elements 11A and 11B and transmits the magnified degree of movement to the contact member BT, it is possible to increase the degree of movement of the contact member BT in the driving direction of the laminated piezoelectric elements 11A and 11B without increasing the length of the laminated piezoelectric elements 11A and 11B.

### Third Embodiment

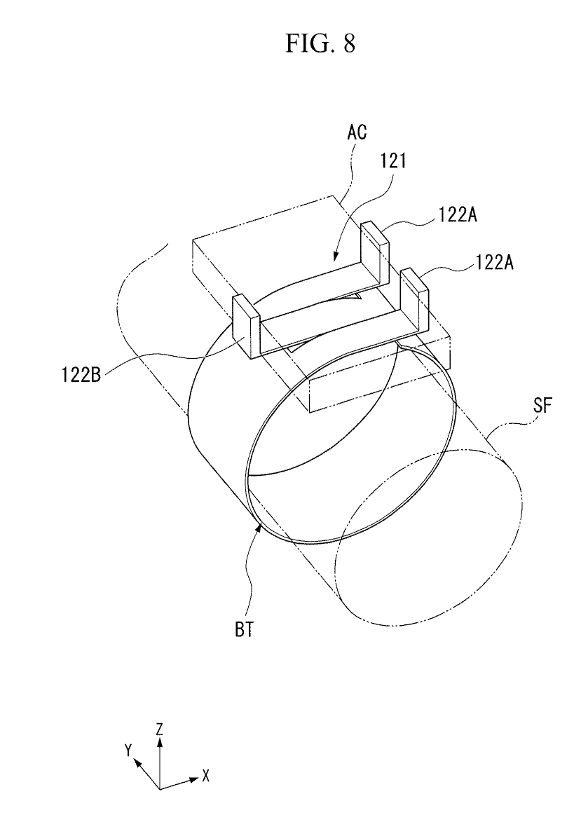

A third embodiment of the invention will be described below with reference to FIGS. 8 to 10.

In FIGS. 8 to 10, the same elements as described in the first embodiment shown in FIGS. 1 to 6C are referenced by the same reference numerals and the description thereof will not be repeated.

The present embodiment has a configuration in which a contact member BT is wound on a rotor SF by a length of one turn (360 degrees) or more.

As shown in FIG. 8, the contact member BT in the present embodiment is formed of a conductive material such as steel, and is in a crossed state where the contact member BT is, for example, wound on the rotor SF by 360-degree roll. The crossed portion (reference position) 121 of the contact member BT has a cross belt structure. Specifically, in the crossed portion 121, a first end portion 122A of the contact member BT is branched into two portions and a second end portion 122B of the contact member BT has a small width. Accordingly, the contact member BT is crossed in a state where the second end portion 122B is disposed between the two branched portions of the first end portion 122A. The first end portion 122A and the second end portion 122B of the contact member BT are connected to the driving unit AC so as to interpose the driving unit AC from the outside.

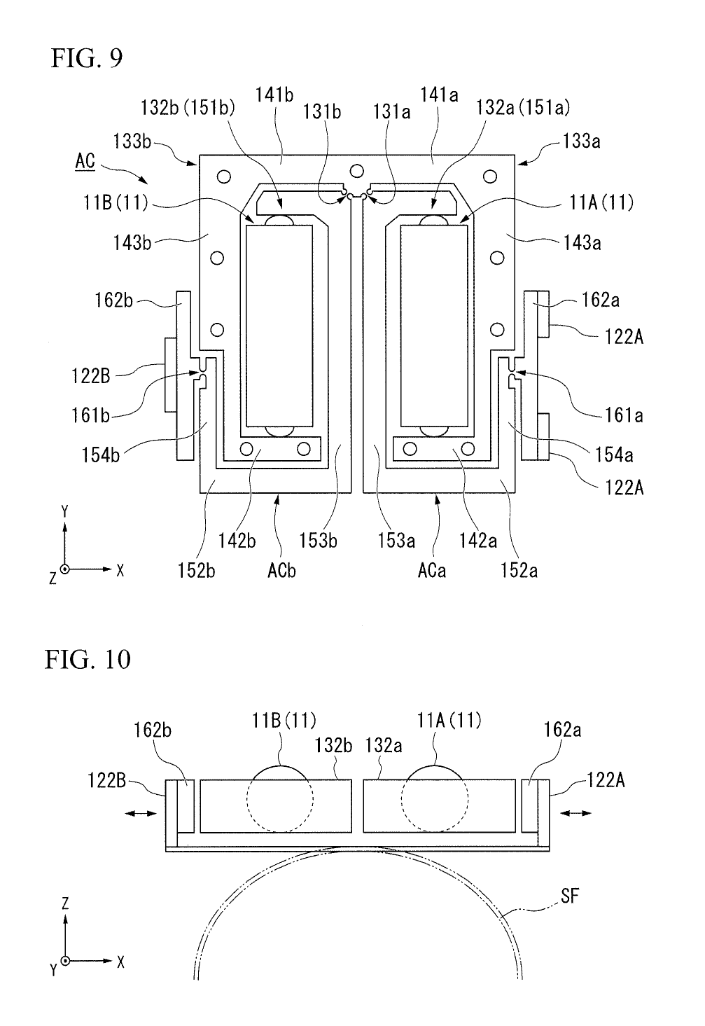

FIG. 9 is a plan view illustrating the configuration of the driving unit AC. FIG. 10 is a front view illustrating the configuration of the driving unit AC.

In FIGS. 9 and 10, the driving direction of the laminated piezoelectric elements 11A and 11B and the rotation axis direction of the rotor SF are defined as a Y direction (the fifth direction), the movement direction of the contact member BT perpendicular to the Y direction is defined as an X direction (the fourth direction), and the direction perpendicular to the Y direction and the X direction is defined as a Z direction (the third direction).

The driving AC shown in FIG. 9 includes a first driving unit ACa which moves the first end portion 122A of the contact member BT and a second driving unit ACb which moves the second end portion 122B. The first driving unit ACa includes a hinge portion 131a having a swing support point around an axis line extending in the Z direction, a movable portion 132a connected to the hinge portion 131a and swinging about the Z axis, and a fixed portion 133a connected to the movable portion 132a via the hinge portion 131a. In the present embodiment, a magnifying mechanism is constructed by the movable portion 132a.

The fixed portion 133a includes rod portions 141a and 142a extending in the X direction and a rod portion 143a bridged between the rod portions 141a and 142a on the +X side of the laminated piezoelectric element 11A extending in the Y direction, and is formed in a substantially rectangular arc shape. The rod portion 142A located on the −Y side is connected to an end of the laminated piezoelectric element 11A from the −Y side.

The movable portion 132a includes rod portions 151a and 152a extending in the X direction, a rod portion 153a bridged between the rod portions 151a and 152a on the −X side of the laminated piezoelectric element 11A extending in the Y direction, and a rod portion 154a extending in the Y direction and extending to the +Y side from an end portion of the rod portion 152a on the +X side, and is formed in a substantially rectangular ring shape of which one side is partially cut out. The rod portion 151a located on the +Y side is disposed on the −Y side of the rod portion 141a with a gap therebetween and constitutes a second connecting portion connected to the other end of the laminated piezoelectric element 11A from the +Y side. The rod portion 152a located on the −Y side is disposed at the −Y side of the rod portion 142a with a gap interposed therebetween. The rod portion 154a is disposed at the +X side of the rod portion 143a with a gap interposed therebetween.

At an end on the +Y side of the rod portion 154a, a connecting portion 162a extending in the Y direction and being connected thereto with a hinge portion 161a having a swing support point around an axis line extending in the Z direction is disposed at the +X side of the rod portion 154a with a gap therebetween. The first end 122A of the contact member BT is connected to the connecting portion 162a from the +X side.

In FIG. 9, the swing radius of the connecting portion 162a, which the hinge portion 131a is a swing support point, is larger than the swing radius of the rod portion 151a, which the hinge portion 131a is a swing support point.

The second driving unit ACb and the first driving unit ACa are disposed symmetric about a line crossing the axis of rotation of the rotor SF and extending in the Y axis direction. In FIGS. 9 and 10, the elements of the second driving unit ACb are described by changing the corresponding subscripts of the first driving unit ACa from a to b, and the description thereof will not be repeated. The second end portion 122B of the contact member BT is connected to the connecting portion 162b of the second driving unit ACb from the −X side.

In the driving unit AC having the above-mentioned configuration, when the laminated piezoelectric element 11A contracts, for example, in the length direction by the electrification thereof, the movable portion 132a swings in the clockwise direction around the Z axis as having the hinge portion 131a as a swing support point. By the swing of the movable portion 132a, which the hinge portion 131a is a swing support point, the connecting portion 162a moves substantially in the −X direction via the hinge portion 161a. At this time, the movable portion 132a inclines in the Y direction by the swing around the Z axis. And then, the connecting portion 162a swings in a counterclockwise direction around the Z axis relative to the rod portion 154a about the hinge portion 161a, the connecting portion 162a moves in the −X direction in a state where it extends in the Y direction. By the movement of the connecting portion 162a in the −X direction, the first end portion 122A of the contact member BT moves in the −X direction and the winding of the contact member BT on the rotor SF is loosened.

The degree of movement of the connecting portion 162a and the first end portion 122A is set depending on the ratio of the swing radius of the connecting portion 162a, which the hinge portion 131a is a swing support point, and the swing radius of the rod portion 151a, which the hinge portion 131a is a swing support point.

For example, when the distance between the rod portion 151a and the hinge portion 131a is defined as L151, and the distance between the connecting portion 162a and the hinge portion 131a is defined as L162, the degree of movement of the connecting portion 162a is expressed by the following Expression 2.

(Degree of Displacement of Laminated Piezoelectric Element 11A)×(L162/L151) Expression 2

In Expression 2, the degree of movement of the connecting portion 162a is a value obtained by magnifying the degree of displacement (the degree of drive) of the laminated piezoelectric element 11A to (L162/L151) times through the use of the movable portion 132a as a magnifying mechanism.

Therefore, the first end portion 122A of the contact member BT connected to the connecting portion 162a moves in the −X direction substantially perpendicular to the driving direction of the laminated piezoelectric element 11A with the degree of movement which is a value obtained by magnifying the degree of displacement of the laminated piezoelectric element 11A.

On the contrary, when the laminated piezoelectric element 11A expands in the length direction through the electrification thereof, the movable portion 132a swings in the counterclockwise direction around the Z axis as having the hinge portion 131a as a swing support point. Accordingly, oppositely to the above-mentioned description, the first end portion 122A of the contact member BT connected to the connecting portion 162a moves in the +X direction with the degree of movement which is a value obtained by magnifying the degree of displacement of the laminated piezoelectric element 11A, and can give an effective tension to the rotor SF.

Similarly, when the laminated piezoelectric element 11B expands and contracts, the movable portion 132b swings around the Z axis as having the hinge portion 131b as a swing support point according to the expansion and contraction direction, and the second end portion 122B of the contact member BT moves in the X direction, whereby it is possible to adjust the giving of a tension to the rotor SF from the contact member BT and the loosening of the contact member BT.

By appropriately adjusting the degrees of displacement of the laminated piezoelectric elements 11A and 11B with the same elapsed time as shown in FIGS. 6A-6C, it is possible to continuously give a torque to the rotor SF.

### Fourth Embodiment

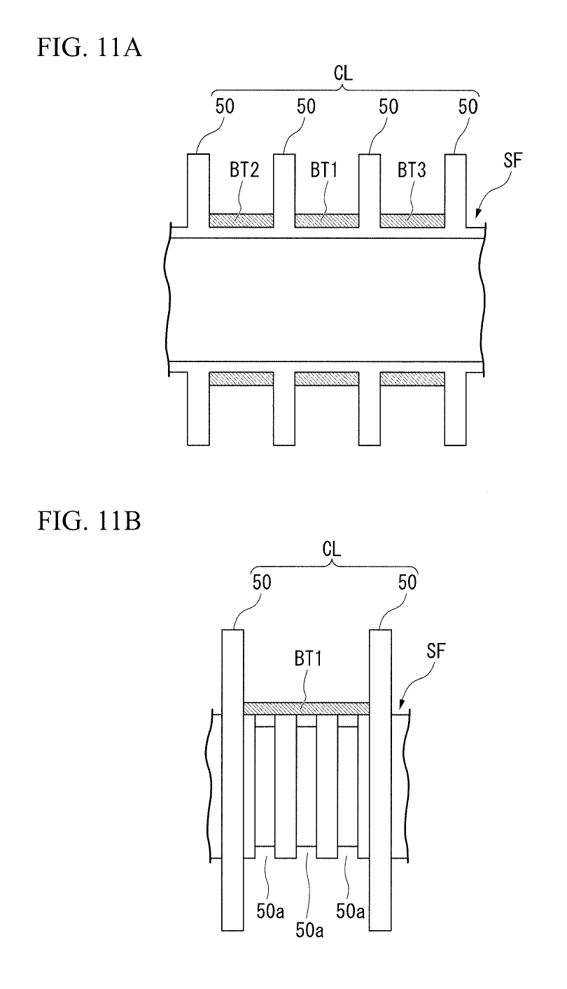

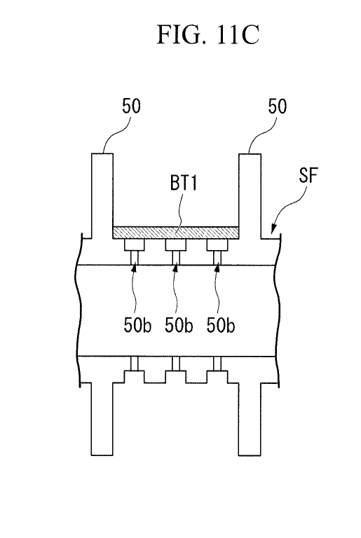

A fourth embodiment of the invention will be described below with reference to FIGS. 11A, 11B, and 11C.

This embodiment is different from the first and second embodiments in the configuration of the rotor SF and thus the rotor SF will be described below.

As shown in FIG. 11A, plural (four herein) disc-like protrusions 50 are disposed at the outer circumferential surface (surface) of the rotor SF in the rotation axis direction with a gap which is a width allowing the contact members BT1 to BT3 to be fitted thereto. The contact members BT1 to BT3 are guided by the protrusions 50 and are wound on the outer circumferential surface of the rotor SF.

The other configuration is similar to that of the first and second embodiments.

In the rotor SF having the above-mentioned configuration, the contact members BT1 to BT 3 are guided by the protrusions 50. Accordingly, even when the rotor SF rotates, it is possible to stably give a torque to the rotor SF without causing a positional difference in the rotation axis direction. In the rotor SF according to the present embodiment, since the heat dissipation is promoted by the protrusions 50, the protrusions serve as a cooler (the second cooler) CL. Accordingly, even when heat is generated due to the friction with the contact members BT1 to BT3 or the like, it is possible to effectively cool the heat and thus to avoid a torque due to the frictional heat acting on the rotor SF.

As the cooler CL disposed at the rotor SF, as shown in FIG. 11B, a configuration in which plural (three herein) grooves 50a are formed on the outer circumferential surface of the rotor SF around the axis of rotation may be used in addition to the protrusions 50.

In this configuration, since the surface area of the rotor SF increases due to the grooves 50a to raise the heat dissipation efficiency, and a gap is formed between the rotor SF and the contact member BT1 to radiate heat, it is possible to greatly raise the cooling efficiency. In this configuration, since frictional powder formed by the friction between the rotor SF and the contact member BT1 can be discharged through the grooves 50a, it is possible to prevent the frictional force from varying due to the frictional powder existing between the rotor SF and the contact member BT1 to cause the torque given to the rotor SF to vary.

As the cooler CL disposed at the rotor SF, as shown in FIG. 11C, a configuration in which the rotor SF is formed to have a cylindrical hollow structure and through-holes 50b penetrating the outer circumferential surface and the hollow portion are formed may be employed.

In this configuration, similarly to the configuration shown in FIG. 11B, it is possible to discharge the frictional heat and the frictional powder to the hollow portion through the through-holes 50b. In this configuration, since the scattering of the frictional powder can be suppressed, it is possible to suppress the variation in torque on the rotor SF due to the frictional powder.

### Fifth Embodiment

A fifth embodiment of the invention will be described below.

In the present embodiment, an application example of the motor apparatus will be described.

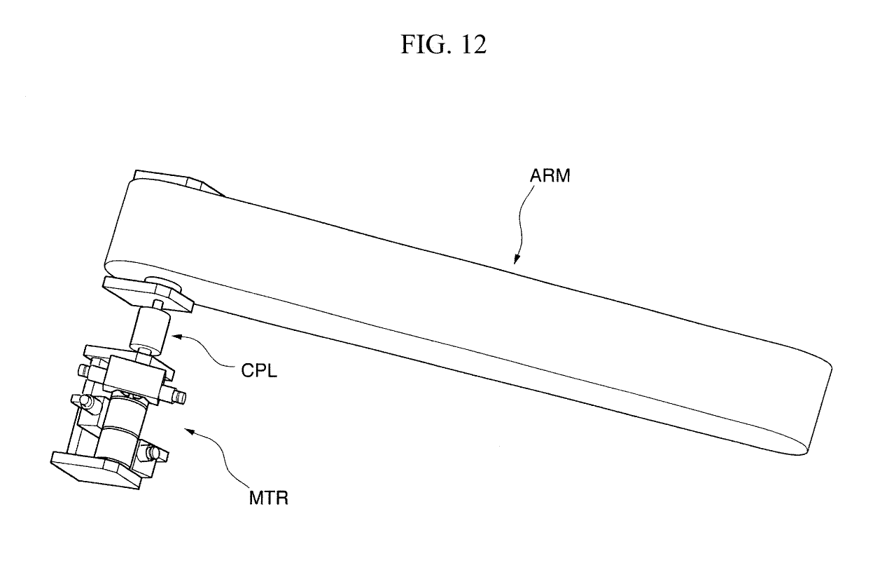

FIG. 12 is a diagram illustrating a configuration in which the motor apparatus MTR is applied to, for example, a robot arm.

As shown in FIG. 12, the motor apparatus MTR is connected to a robot arm ARM via coupling CPL. Since the motor apparatus MTR according to the above-mentioned embodiments is small and can output a high torque, it is possible to drive the robot arm ARM with a high precision. The motor apparatus MTR according to the above-mentioned embodiments can be applied to a joint part (such as a finger joint part) of the robot or a driving unit of a machine tool.

While the exemplary embodiments of the invention have been described with reference to the accompanying drawings, the invention is not limited to the embodiments. All the shapes or combinations of the constituent members described in the above-mentioned embodiments are only examples and can be modified in various forms on the basis of design requirements without departing from the concept of the invention.

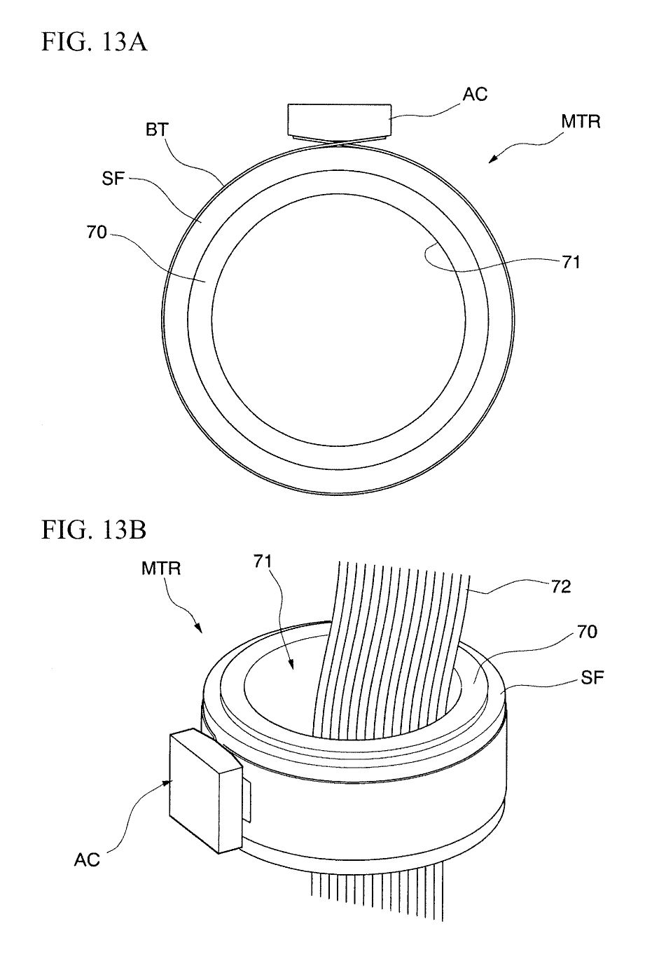

For example, the above-mentioned embodiments employ the configuration in which the rotor has a solid core (a non-hollow structure), but the invention is not limited to this configuration. For example, when the motor apparatus MTR is mounted on a revolving type machine such as a robot arm ARM or the like, the rotor SF may be configured to have a hollow structure as shown in FIG. 13A. As shown in FIG. 13A, the rotor SF includes a hollow portion 71 penetrating the rotor in the rotation axis direction. A cylindrical bearing 70 is disposed at the penetrated portion 71. The rotor SF can rotate about the bearing 70.

As shown in FIG. 13B, wires 72 or the like may be disposed inside of the bearing 70. In this way, the rotor SF may also be used as a wiring pipe.

It is stated in the above-mentioned embodiments that the torque transmission state is a state where the rotor SF and the contact member BT do not slip each other due to the frictional force, but the invention is not limited to this state.

For example, as shown in FIG. 14, a state where the rotor SF and the contact member BT engage with each other may be set as the torque transmission state. As shown in FIG. 14, protrusions 171 are formed on the rotor SF and grooves 172 are formed on the contact member BT so as to gear with the protrusions 171. In this way, a configuration in which a torque is transmitted by causing the protrusions 171 of the rotor SF and the grooves 172 of the contact member BT to engage with each other may be employed. For example, the direction in which the protrusions 171 of the rotor SF are formed is not particularly limited, and may be a random direction, the rotation axis direction of the rotor SF, the circumferential direction of the rotor SF, or the like. In the present embodiment, a configuration in which grooves are formed on the rotor SF and protrusions are formed on the contact member BT may be employed. The size of the protrusions (for example, the protrusions 171) or the grooves (for example, the grooves 172) are not particularly limited, but it is preferable that the size is small enough to loosen the contact member BT through the use of the driving unit AC or small enough to form a gap between the rotor SF and the contact member BT through the use of the driving unit AC. Here, the engagement in the present embodiment includes causing the protrusions 171 of the rotor SF and the grooves 172 of the contact member BT to gear with each other, fitting the protrusions 171 of the rotor SF and the grooves 172 of the contact member BT to each other, matching the protrusions 171 of the rotor SF and the grooves 172 of the contact member BT with each other, and the like. The protrusions 171 of the rotor SF and the grooves 172 of the contact member BT do not have to completely engage with each other.

It is stated in the above-mentioned embodiments that the contact member BT is formed in a belt shape, but the contact member BT is not limited to this shape, and may be formed, for example, in a line shape or a chain shape.

In the above-mentioned embodiments, since the tension of the contact member BT can be controlled on the basis of the displacement of the laminated piezoelectric element 11, it is possible to control the holding torque even when the driving is stopped.

For example, by appropriately controlling the degree of displacement of the laminated piezoelectric element 11 through the use of the driving unit AC in the above-mentioned embodiments, it is possible to give a brake function.

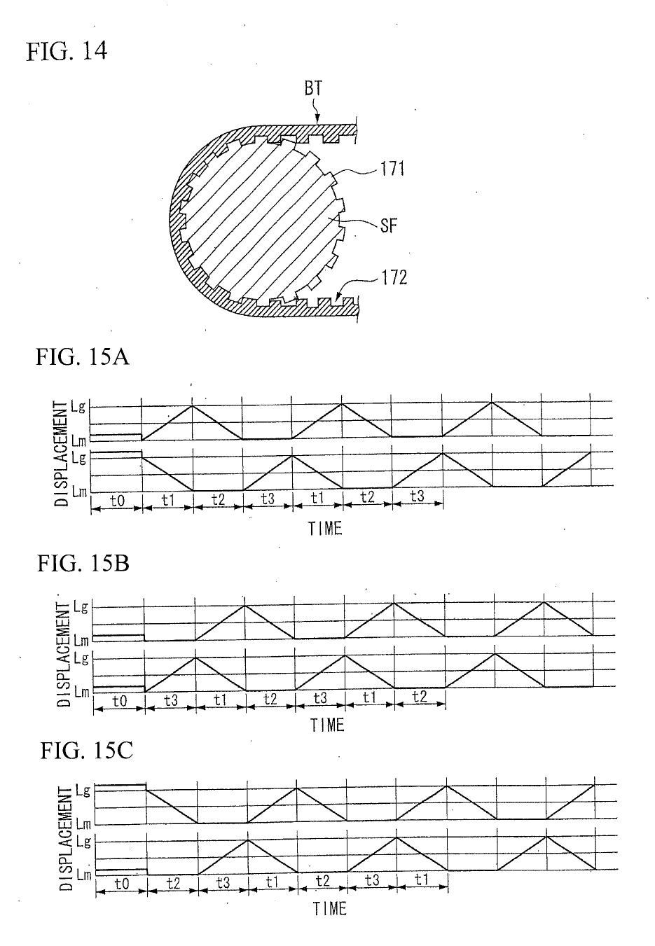

For example, regarding the driving unit AC described in the first embodiment, in the timing diagram shown in FIGS. 15A-15C, an interval of time t0 as a brake interval is additionally provided to the timing diagram shown in FIGS. 6A-6C.

During the interval of time t0, by causing the laminated piezoelectric elements 11A and 11B to expand with a degree of displacement slightly greater than the degree of displacement Lm, a tension is given to both ends of the contact member BT and can be made to act as a braking force of the rotor SF. When not rotating the rotor SF, the driving unit AC adjusts the movement of the contact member BT in a state where the rotor SF and the contact member BT are brought into contact with each other. Accordingly, the driving AC can stop the rotation of the rotor SF or can hold the stopped state.

It has been stated in the above-mentioned embodiments that the driving unit AC which drives the contact member BT includes an electrostrictive element, but the invention is not limited to this configuration. For example, the driving unit may employ another actuator such as a magnetostrictor, an electromagnet, or a VCM (Voice Coil Motor) instead of the electrostrictive element. For example, when a magnetostrictor is used, it is possible to enhance the thrust.

When an electromagnet is used, it is possible to drive the rotor with a high thrust and a long stroke. When a VCM is used, it is possible to drive the rotor with a long stroke and it is easy to control the torque.

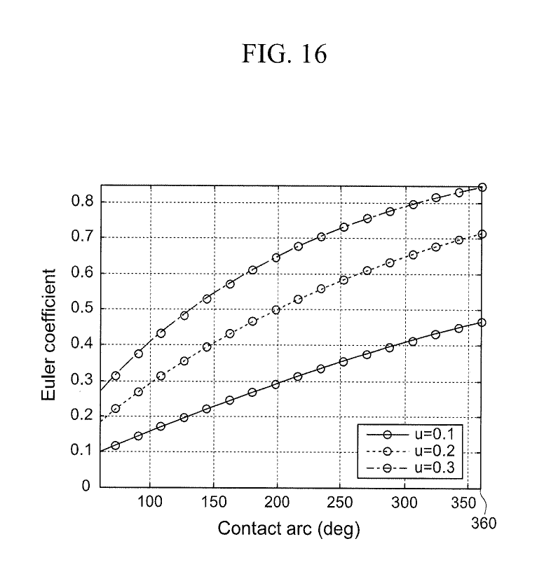

For example, Euler's friction belt theory is used in the operation of driving the rotor SF in the above-mentioned embodiments as shown in FIG. 16. FIG. 16 is a graph illustrating the relationship between an effective winding angle θ and an Euler coefficient when the frictional coefficient μ is changed. As shown in FIG. 16, for example, when the frictional coefficient μ is 0.3, the value of the Euler coefficient is 0.8 at an effective winding angle θ of 300° or more. Accordingly, when the frictional coefficient μ is 0.3, it can be seen that an 80% or more force of the tension from the driving unit AC contributes to the torque of the rotor SF by setting the effective winding angle θ to 300° or more.

What is claimed is:

1. A motor apparatus comprising:
a rotor;
a contact member wound around at least a part of a circumference of the rotor;
a driving unit that is connected to the contact member and that moves the contact member;
a magnifying mechanism that magnifies a degree of movement of the contact member based on a degree of drive of the driving unit and that transmits the magnified degree of movement to the contact member; and
a control unit that controls the driving unit to perform a driving action of moving the contact member in a predetermined distance while setting up a torque transmission state between the rotor and the contact member, and a returning action of returning the contact member to a predetermined position while having the torque transmission state released.

2. The motor apparatus according to claim 1, wherein the magnifying mechanism moves the contact member to move in a movement direction which is substantially the same direction as a drive direction of the driving unit.

3. The motor apparatus according to claim 2, wherein the magnifying mechanism comprises a swing support point around an axis line extending in a first direction at one end thereof, a connecting portion in which the contact member is connected to an other end thereof such that the movement direction crosses the first direction, and a second connecting portion where the driving unit is connected between the swing support point and the connecting portion.

4. The motor apparatus according to claim 1, wherein the magnifying mechanism moves the contact member in the movement direction which crosses with the drive direction of the driving unit.

5. The motor apparatus according to claim 4, wherein the magnifying mechanism comprises a Moonie converter that converts the drive direction of the driving unit into the movement direction.

6. The motor apparatus according to claim 5, wherein the Moonie converter comprises a fixed portion disposed at both ends in the drive direction of the driving unit, a pair of rod portions of which one end is connected to the fixed portion via a hinge portion which can swing around an axis line extending in a second direction that crosses with the drive direction, and a second rod portion connected to the contact member which is connected to an other end of the pair of rod portions via a second hinge portion which can swing around an axis line extending in the second direction.

7. The motor apparatus according to claim 6, wherein the pair of rod portions and the second rod portion are disposed at both sides in a width direction of the driving unit.

8. The motor apparatus according to claim 4, wherein the magnifying mechanism comprises a swing support point around an axis line extending in a third direction, a connecting portion where the contact member is connected in which a fourth direction crossing with the third direction is set as a movement direction of the contact member, and a second connecting portion where the driving unit is connected in which a fifth direction crossing the third direction and the fourth direction is set as a drive direction of the driving unit, and that swings about the swing support portion when the driving unit is driven.

9. The motor apparatus according to claim 8, wherein the magnifying mechanism comprises a hinge apparatus in that the swing radius of the connecting portion from the swing support point is larger than a swing radius of the second connecting portion from the swing support point.

10. The motor apparatus according to claim 1, wherein the driving unit comprises an electrostrictive element.

11. The motor apparatus according to claim 1, wherein the contact member is formed in any of a line shape, a belt shape, and a chain shape.

12. The motor apparatus according to claim 1, wherein the contact member is formed to be elastically deformable.

13. The motor apparatus according to claim 1, further comprising a cooler that cools the driving unit.

14. The motor apparatus according to claim 13, wherein the cooler is disposed between the driving unit and a supporting portion which supports the driving unit.

15. The motor apparatus according to claim 1, wherein the rotor comprises a second cooler that cools the contact member.

16. The motor apparatus according to claim 15, wherein the second cooler comprises a protrusion formed on a surface of the rotor.

17. The motor apparatus according to claim 16, wherein the protrusion is disposed at a position where the contact member is guided.

18. The motor apparatus according to claim 15, wherein the second cooler comprises a groove formed on a surface of the rotor.

19. The motor apparatus according to claim 1, wherein the rotor is formed hollow.

20. The motor apparatus according to claim 1, wherein a plurality of the contact member is provided.

21. The motor apparatus according to claim 20, wherein the driving unit is disposed for each of the plurality of contact member, and
wherein the plurality of driving unit is arranged at different positions in a rotation direction of the rotor.

22. The motor apparatus according to claim 1, wherein the driving unit adjusts the movement of the contact member in a contact state where the rotor and the contact member are in contact with each other when the rotor is not made to rotate.

23. A method of driving a rotor, comprising:
a driving that moves a contact member wound around a rotor in a predetermined distance while setting up a torque transmission state between the rotor and the contact member by driving of a driving unit; and
a returning the contact member to a predetermined position while having the torque transmission state released by the driving of the driving unit,
wherein at least one of the driving and the returning comprises magnifying a degree of movement of the contact member based on a degree of drive of the driving unit and transmitting the magnified degree of movement to the contact member.

24. A robot apparatus comprising:
a rotating shaft member; and
a motor apparatus that causes the rotating shaft member to rotate,
wherein the motor apparatus according to claim 1 is used as the motor apparatus.
